(19) United States
(12) Patent Application Publication
(10) Pub. No.: US 2010/0129085 A1
(43) Pub. Date: May 27, 2010

(54) PLASMONIC SYSTEMS AND DEVICES UTILIZING SURFACE PLASMON POLARITON

(76) Inventors: Igor I. Smolyaninov, Columbia, MD (US); Uzi Vishkin, Potomac, MD (US); Christopher C. Davis, Bowie, MD (US)

Correspondence Address: CARTER, DELUCA, FARRELL & SCHMIDT, LLP, 445 BROAD HOLLOW ROAD, SUITE 420, MELVILLE, NY, 11747, US

(21) Appl. No.: 12/697,595

(22) Filed: Feb. 1, 2010

Related U.S. Application Data
(62) Division of application No. 11/646,734, filed on Dec. 28, 2006.
(60) Provisional application No. 60/743,696, filed on Mar. 23, 2006.

(51) Int. Cl. H04B 10/12

(52) U.S. Cl. 398/141

(57) ABSTRACT

Plasmonic systems and devices that utilize surface plasmon polaritons (or “plasmons”) for inter-chip and/or intra-chip communications are provided. A plasmonic system includes a microchip that has an integrated circuit module and a plasmonic device configured to interface with the integrated circuit module. The plasmonic device includes a first electrode, a second electrode positioned at a non-contact distance from the first electrode, and a tunneling-junction configured to create a plasmon when a potential difference is created between the first electrode and the second electrode.

### PRIORITY

The present application is a divisional application of U.S. patent application Ser. No. 11/646,734 filed on Dec. 28, 2006 titled “PLASMONIC SYSTEMS AND DEVICES UTILIZING SURFACE PLASMON POLARITONS” which claims priority to United States provisional application filed on Mar. 23, 2006 titled “Plasmonics for Improved Bandwidth in Intra-chip and Inter-chip Communications and Advances in Computer Architecture” and assigned U.S. Provisional Application Ser. No. 60/743,696; the entire contents of both of which are incorporated herein by reference.

### BACKGROUND

1. Technical Field

The present disclosure relates generally to plasmonics and the generation and utilization of surface plasmon polaritons. The surface plasmon polartions can be utilized for intra- and inter-microchip communications.

2. Description of the Related Art

There has been a continuing need for higher data transfer rates and/or lower latencies in semiconductors. For example, a computer architecture that has one, or more, processors and some fast memories (e.g., caches) on a single chip may require significant data throughput between the various sections of the chip and/or to other chips. Reaching larger memories off-chip (i.e., lower levels in the memory hierarchy, such as main memory), or other processors off-chip in a multi-processor organization, requires off-chip connections through metallic pins on the boundary of the chips. Such connections may have parasitic capacitances, or be subject to other constraints, that limit bandwidth to values insufficient for the application and/or result in a bottleneck.

More recently, there has been a surge in the need for higher data transfer rates between sections of a microchip and/or between multiple microchips. This has developed as a result of the very high operating speeds now possible by integrated circuitry. For example, modern computers have a central processing unit that can finish computations so quickly that the time needed to retrieve additional data from memory, i.e. random access memory, may be much longer in comparison to the computation time. Modern computers spend a significant amount of time “idling” i.e. waiting for the memory to transfer data to the central processing unit so that more computing can occur.

Several techniques are currently used to mitigate some aspect of these problems. For example, memory is generally organized in levels or in some sort of hierarchy, i.e. caching. Some data is located in faster memory that tends to have less capacity while other data is stored in slower memory that tends to have greater capacity. Here, the most commonly used data is generally stored in faster memory while other data is stored in slower memory, sometimes on another device. The layers of memory are usually “mapped” to lower levels in the memory hierarchy. The goal is to have data that is more likely to be accessed at the time in faster memory so that a processor doesn't spend too much time “idling”.

Unfortunately, the proximity of the memory is related to the speed of data retrieval because of the physical characteristics of transmitting data over wires utilizing an electrical signal. When a digital communications link utilizes an electrical signal that is transmitted over a metallic wire or structure, the data transfer rate is, in large part, a function of the frequency of the carrier signal. Since higher data transfer rates are always in demand, there has been a steady increase in the carrier signal frequency used in semiconductors. Because of the higher frequencies used, special precautions must be made to ensure that length-based losses are minimized. Even with these measures, data transfer rates generally are limited by the distance of the transmission wires; and parasitic capacitances that may not have limited performance in the past are now having a large impact on performance. With the increased operating speeds of integrated circuitry there has been a need to provide high speed communications between sections of a microchip and/or between other semiconductors based devices despite the distances involved.

Another technology that may alleviate some of the bottlenecks that have resulted from inadequate data transfer rates is “photonics”. “Photonics” is a technology that includes the utilization of photons to transfer data. The data transfer rates that have been achieved using photonics are significantly greater compared to the rates of electrical signals over traditional metallic wires. The technologies available for using photonics include fiber optics, optical waveguides, photoemitters, photodetectors, and multiple variations of these. The utilization of photonics to form optical interconnections is a possible solution to the bottleneck problems that are occurring between the various parts of a microchip.

Optical interconnects for intra-microchip and/or inter-microchip data communications have the potential to provide very high data transfer rates. Optical technologies can provide connections with zero or minimal parasitic capacitance and tend to have highly directional data flows. In addition, crosstalk between multiple interconnects may be minimized by the use of photonics. Such optical connections may also be free-space, use optical fibers, or may be guided by on-board waveguides. Unfortunately, to date, the use of optical interconnects has focused on a mixed fabrication environment. The standard fabrication technology used for digital electronics is silicon-based, a technology which lends itself more easily to the fabrication of silicon photodetectors, but not so easily to photoemitters. Because silicon is an indirect band-gap semiconductor, no effective way is yet known to fabricate efficient electrically-driven light emitting diodes and/or lasers for use with microchips. In addition, optically pumped lasers based on silicon have not been proven useful in a high speed integrated system. Because of the advantages of using optical frequencies in semiconductor devices and/or systems, it may be advantageous to utilize another related particle called a “plasmon”

Plasmonics” is the utilization of plasmons by semiconductors. Plasmonics is an emerging technology based on surface plasmon polaritons (“SPPs”) which are commonly referred to as plasmons. A plasmon is a quasiparticle resulting from the quantization of plasma oscillations. They are a hybrid of the electron plasma and the photon. Thus, plasmons are collective oscillations of the free electron gas approximately at optical frequencies. Plasmons can also be described classically and may be derived directly from Maxwell's equations. They can be described as classical charge density waves. A surface-plasmon polariton can be excited at a positive dielectric constant and a negative dielectric constant interface, e.g. a metallic/dielectric interface.

The advantage of using plasmons is the high data transfer rates that are possible for inter- and/or intra-microchip communications. Also, plasmons, because of the frequencies they utilize, are related to photons in that in certain specific situations a conversion between one to another is possible. There has been a need to utilize plasmons in semiconductor devices because of the potential to alleviate the bottlenecks that are a result of the inadequate data transfer rates that exist on many semiconductor devices and/or systems.

### SUMMARY

Aspects of the present disclosure relate to plasmonic systems and devices. The present disclosure relates to a plasmonic system having a plasmonic device for generating plasmons, a plasmonic system to convert plasmons to photons, a plasmonic system to convert plasmons to an electrical signal, a plasmonic waveguide, a microchip system utilizing plasmons, a plasmonic inter-microchip module communications system, and a computer architecture utilizing plasmonics.

For a better understanding of the present disclosure, it is provided that plasmons do not occur spontaneously in the boundary between metals and dielectrics in the plasmonic structure. Accordingly, plasmons must be excited in the appropriate surface regions of the chip or chips so that they are then available as carriers of data both inter- and intra-chip. Plasmons are created where they are needed by illuminating the appropriate surface regions with an external light source (laser, LED, or conventional source), which is matched to the surface by periodic surface structures such as gratings, nanohole arrays, nanobump arrays. This external light source might be as simple as a light-emitting diode, and is properly part of the “power supply” for the chip. The external light source excites the surface plasmons by a process called “phase-matching,” where part of the needed momentum for momentum conservation is provided by the “quasi-momentum” of the periodic structure on the surface.

Once plasmons are excited, their frequency is the same optical frequency as the exciting light source, but their wavelengths are much shorter, down into the nanometer region. The plasmons are then available to be modulated by chip integrated circuitry so that they become carriers of the data to be transported around either inter- or intra-chip in accordance with the present disclosure.

In one aspect thereof, the present disclosure relates to a plasmonic system that includes a microchip module and a plasmonic device. The microchip module includes an integrated circuit to which the plasmonic device may interface. The plasmonic device includes a first electrode and a second electrode positioned at a non-contact distance from each other. Between the two electrodes there is a tunneling junction provided that is configured to create plasmons when a potential difference across the two electrodes is created. The electrodes may include a plurality of nonojunction that may create 5.times.10 12 plasmons or more per second when a voltage is applied across the nanojunctions.

The system may also include another plasmonic device that communicates with the other plasmonic device and may include a plasmon interface, an optical conversion assembly, and an output device. Also the two plasmonic devices may utilize a plasmonic waveguide. The output device may be a p-i-n diode, a photodiode, an avalanche diode, a p-n junction diode, a phototransistor, a light dependent resistor, a photodetector and/or an optical waveguide. The waveguide includes an elongated metallic strip and a dielectric material. The dielectric material is disposed on the metallic strip and the waveguide may also include an additional metallic strip on the opposite side to the metallic strip.

In another aspect thereof, the present disclosure also relates to a plasmonic system that includes a microchip module and a plasmonic device where the plasmonic device includes a plasmon interface, an optical conversion assembly, and an output device. The microchip module includes an integrated circuit and may be operatively connected to the output device. Also, the plasmon interface may be configured to connect to a plasmonic waveguide. The output device may be a p-i-n diode, a photodiode, an avalanche diode, a p-n junction diode, a phototransistor, a light dependent resistor, and a photodetector.

In another aspect thereof, the present disclosure also relates to a plasmonic communications system that has at least two microchip modules in communication with each other. The communication may be accomplished by a plasmonic waveguide. Also, each microchip module may include an integrated circuit. One of the microchip modules may also include a connection point and a plasmonic device. The connection point may be configured to interface into a plasmonic waveguide. Additionally or alternatively, the connection point may interface into a fiber optic cable. Also, one of the microchips may have a plasmonic device that may include a plasmon interface, an optical conversion assembly and an output device. The plasmon interface may receive a plasmon from the plasmonic waveguide and may convert that plasmon to a photon. The photon may then be routed to the connection point and finally to a fiber optic cable. The microchip modules may be arranged in a stack and/or a flower topology. The waveguide includes an elongated metallic strip and a dielectric material. The dielectric material is disposed on the metallic strip and the waveguide may also include an additional metallic strip on the opposite side to the metallic strip.

In another aspect thereof, the present disclosure relates to a plasmonic device having a first and second electrode that are positioned at a non-contact distance. Between the two electrodes a tunneling junction is provided and may include a dielectric material, for example silicon dioxide. The two electrodes may include a plurality of nanojunction and may create approximately 5.times.10 12 plasmons or more per second when a voltage difference is created between them.

In another aspect thereof, the present disclosure relates to a plasmonic waveguide that includes an elongated metallic strip and a dielectric material. The dielectric material may be disposed on the elongated metallic strip. Also, the waveguide may include another metallic strip disposed opposite to the other metallic strip. The dielectric material may be silicon dioxide.

In another aspect thereof, the present disclosure also relates to a plasmonic device that includes a plasmon interface, an optical conversion assembly, and an output device. The plasmon interface may receive a plasmon from a plasmonic waveguide. And, the optical-conversion assembly may receive a plasmon from the plasmon interface and convert the plasmon to a photon. The photon may then be received by the output device. The output device may be a device for directing the photon to a fiber optic cable, or may be a device that converts the photon to an electrical signal such as a p-i-n diode, a photodiode, an avalanche diode, a p-n junction diode, a phototransistor, a light dependent resistor, and a photodetector, wherein the output device is configured to convert the photon to an electrical signal. The optical conversion assembly may be a surface bump, a surface hole, or a nanoarray.

In another aspect thereof, the present disclosure relates to a computer architecture including a plurality of computer chips. At least one of the plurality of computer chips including at least one of an interconnection network, a processor, cache memory, and a memory. The computer architecture further includes a plurality of connections connecting the plurality of computer chips. At least one of the plurality of connections includes at least one of a plasmonic device and waveguide.

### BRIEF DESCRIPTION OF THE DRAWINGS

These and other advantages will become more apparent from the following detailed description of the various embodiments of the present disclosure with reference to the drawings wherein:

FIG. 1 is a schematic drawing of a plasmonic communications system in accordance with the present disclosure;

FIG. 2A is a schematic drawing of a plasmonic waveguide in accordance with the present disclosure;

FIG. 2B is a schematic drawing of another plasmonic waveguide in accordance with the present disclosure;

FIG. 3 is a schematic drawing of a plasmonic device that can generate plasmons in accordance with the present disclosure;

FIG. 4 is a schematic drawing of a plasmonic device that can convert a plasmon to a photon and then to an electrical signal in accordance with the present disclosure;

FIG. 5 is a schematic drawing of a plasmonic device for converting a plasmon to a photon and guiding the photon to a fiber optic cable by an optical waveguide in accordance with the present disclosure;

FIG. 6 is a schematic drawing of plasmonic communications system in a flower topology in accordance with the present disclosure;

FIG. 7 is a schematic drawing of a plasmonic communications system in a stack topology in accordance with the present disclosure; and

FIGS. 8-10 are block diagrams of different computer architectures utilizing plasmonic devices or waveguides in accordance with the present disclosure for various connections.

### DETAILED DESCRIPTION

The present disclosure relates to systems and devices for utilizing surface-plasmon polaritons (“plasmon”) with integrated circuit technologies. The utilizing of plasmons by/with semiconductor devices is referred herein as “plasmonics” and is used to refer to the use of plasmons by semiconductors for inter-chip and intra-chip communications.

The adjective “plasmonic” is used herein to describe a device or a system that utilizes plasmons for inter-chip and/or intra-chip communications.

The words “microchip” or “chips” are used herein interchangeably. They are defined herein as a device (or system) with integrated circuits, plasmonic device, or some combination thereof. For example, a microchip may only utilize plasmons. In addition or in the alternative, a microchip can have a device that utilizes plasmons and integrated circuitry. Also, the term may be used to describe a device (or system) that only utilizes integrated circuitry. The meaning of the term is to be regarded in context of the description of the item being referenced.

The phrase “microchip module”, may be a microchip, or may be part of a microchip. For example, two microchip modules may be two layers within the same microchip, additionally or alternatively, may exist on two separate microchips.

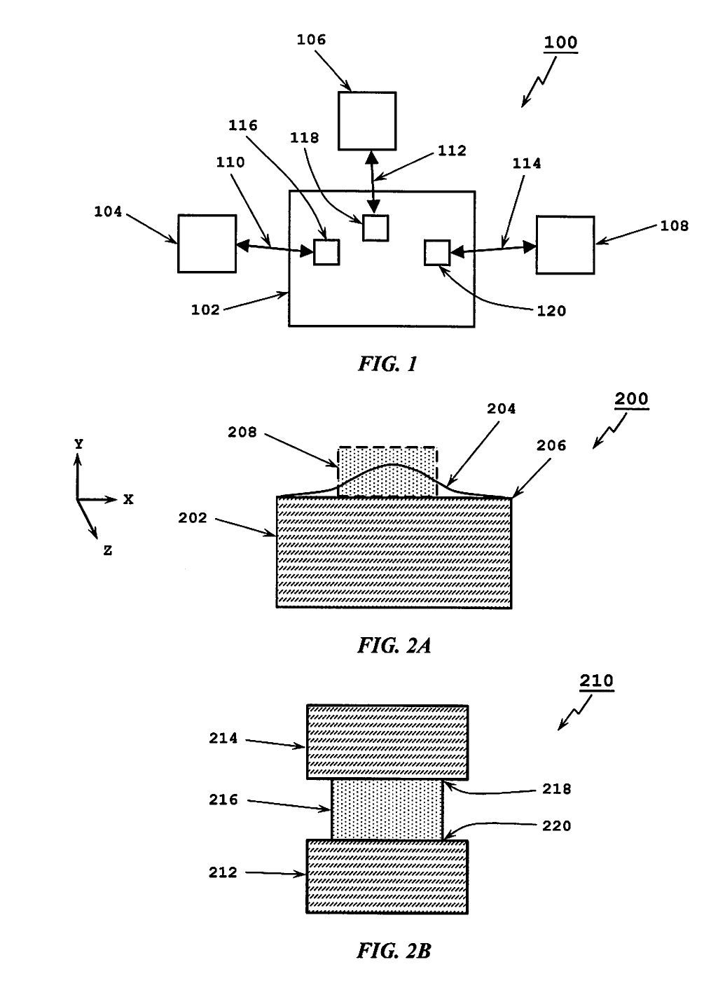

Referring now to the drawings, FIG. 1 is a schematic diagram of a plasmonic system that utilizes plasmons for communications. System 100 includes a microchip module 102. Also, microchip modules 104, 106, and 108 are shown and are connected to microchip module 102 by links 110, 112, and 114, respectively.

Also, microchip module 104 is connected to module 116 by link 110; microchip module 106 is connected to module 118 by link 112; and, microchip module 108 is connected to module 120 by link 114.

Microchip module 116 can include plasmonic devices, memory, processors, cores, multiprocessors, multicores or some combination thereof, likewise microchip modules 104, 106, 108 can include any of the aforementioned integrated circuitry or plasmonic devices. Modules 116, 118, and 120 include a plasmonic device to couple to links 110, 112, and 114, respectively; also, microchip modules 104, 106, and 108 include a plasmonic device to couple to links 110, 112, and 114, respectively. Connections 110, 112, 114 can either be a plasmonic waveguide or a fiber optic cable.

Links 110, 112, and 114 may be plasmonic waveguides or fiber optic cables.

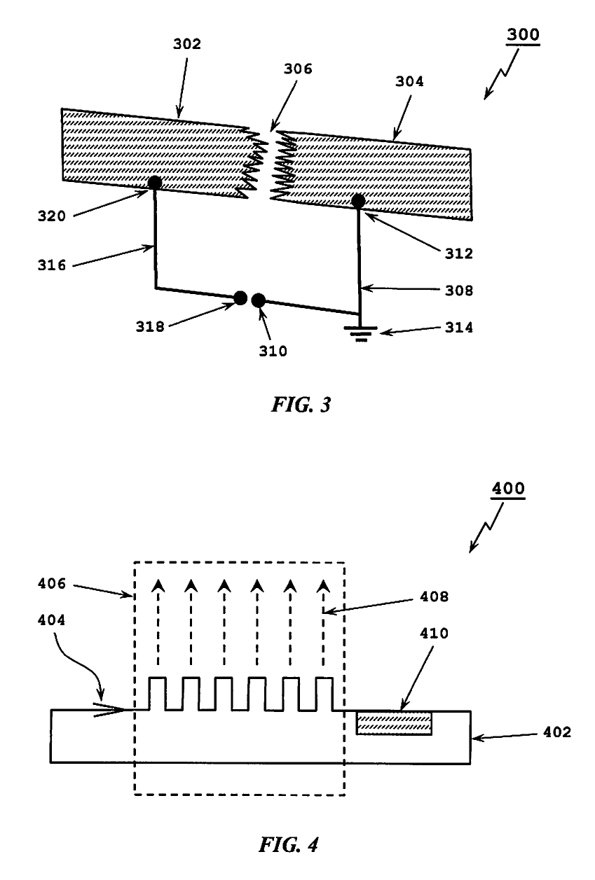

While cross-referencing FIG. 1, turn to FIG. 2A and FIG. 2B which shows a cross-sectional view of two plasmonic waveguides for guiding plasmon approximately along a desired path. Waveguide, 200 and 210 may be included in links 110, 112, and/or 114. The waveguides may have physical dimensions several orders of magnitude smaller than the dimensions of regular optical waveguides. Waveguide 200 and/or 210 may be as small as approximately 100 nm, perhaps even smaller, e.g. 60.times.60 nm.sup.2. Waveguide 200 and/or 210 might typically be 20-60 nm thick and 20-10 nm wide.

The waveguides depicted in FIG. 2A and FIG. 2B can be utilized for intra-chip communications, such as among module, 116, 118, and 120 in FIG. 1, or for inter-chip communications as between microchip module 102 and microchip module, 104, 106, and 108, respectively, when the respective modules are located on differing microchips.

FIG. 2A is a schematic cross-sectional view of plasmonic waveguide 200 for guiding plasmons approximately along the Z-axis. Waveguide 200 has a metallic material 202 and a dielectric material 204 that forms interface 206. Interface 206 is the portion that may guide the plasmons. Box 208 surrounds an area to point out the “bump” that may be formed by dielectric material 204.

FIG. 2B is a schematic cross-sectional view of plasmonic waveguide 210 for guiding plasmons along the Z-axis. Waveguide 210 shows a metallic material 212 and a metallic material 214 with dielectric material 216 positioned in between. Interface 218 is the portion of waveguide 210 where metallic material 214 meets dielectric material 216; likewise, interface 220 is the portion of waveguide 210 where metallic material 212 meets dielectric material 216.

Metallic material 202, 212 or 214 can include the metals: silver, gold, copper, titanium, chromium, aluminum or a metallically-doped semiconductor material. Dielectric material 204 and dielectric material 216 can include silicon dioxide.

FIG. 2A and FIG. 2B are examples of plasmonic waveguides that can be incorporated into microchips with integrated circuits and/or can be utilized on microchips without integrated circuits. For example, waveguide 200 or waveguide 210 can be used on a microchip that has only plasmonic devices to create a plasmonic routing microchip. Additionally or alternatively, waveguide 200 or waveguide 210 can be used to interface plasmons with other microchips, such as in one embodiment of FIG. 1. Also, conversion of plasmons to photons for use in fiber optic interconnects may also be employed while communicating inter-chip and/or intra-chip.

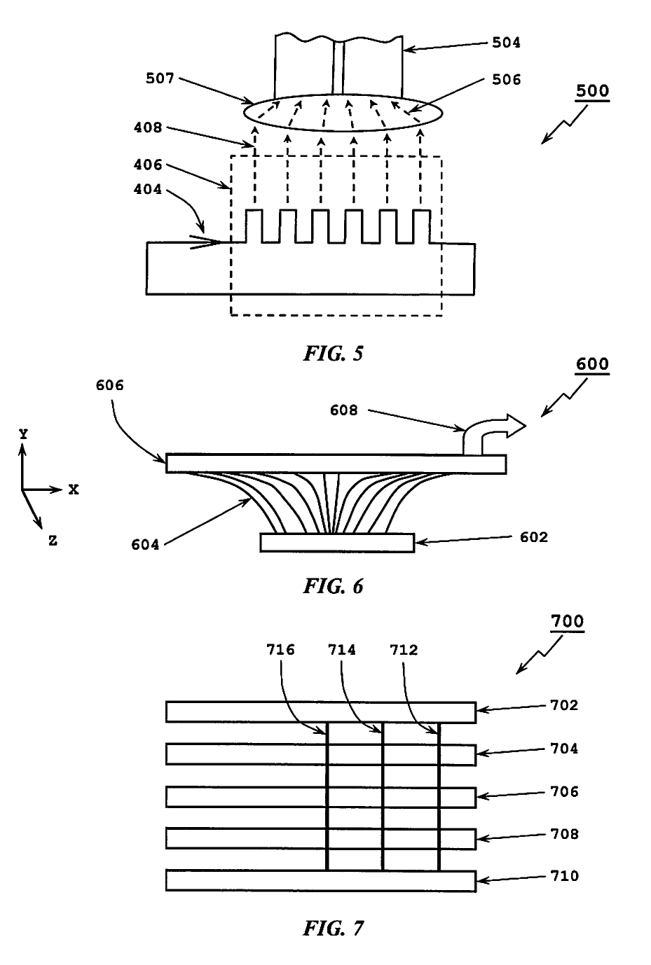

Referring back to FIG. 1, one embodiment of system 100 is to use plasmonics to facilitate caching. For example, module 116 may include memory that a processor (not shown) on chip 102 utilizes for caching that is mapped to memory found in microchip module 104. To perform a caching function, the cache found in module 116 may need to update the respective memory in microchip module 104. Module 116 may utilize plasmons to send data to microchip module 104 by generating plasmons within module 116 by a plasmonic device (see FIG. 3, infra) and likewise may have plasmonic device to receive plasmons (see FIGS. 4 and 5, infra.).

While referencing FIG. 1, FIG. 3 depicts a plasmonic device used to generate plasmons for use in communications as depicted in FIG. 1. The device 300 may be utilized in intra-chip and/or inter-chip communications. Device 300 may have dimensions, for example, of approximately 60.times.60 nm.sup.2. Device 300 may also measure, for example, 20-60 nm thick on the surface, with a lateral dimension as small as 20 nm.

Device 300 includes an electrode 302 that is a non-contact distance from electrode 304. A tunneling-junction 306 is shown. Schematic connection 310 is shown to illustrate that another device (not shown) can be electrically connected to electrode 304, e.g. an integrated circuit that may be in module 116 of FIG. 1 to transmit caching data. Thus, schematic wire 308 has connection 310 where another device (not shown) may be electrically connected to electrode 304 via schematic connection 312. Schematic connection 308 may be an actual metallic conductor or may represent an electrical connection made directly by another device (not shown) without the aid of additional conductive medium. Schematic connection 308 is intended to represent any known way of connecting another device (not shown) with electrode 304.

Additionally, reference numeral 314 is shown and refers to a potential differential that may be created between electrode 304 and 302. Reference numeral 314 may be a ground, may be floating, or may be connected to another electrical reference; furthermore it is intended that reference numeral 314 is used for referring to a potential reference within device 300.

Additionally, schematic connection 316 is shown to illustrate that another device (not shown) may be electrically connected to electrode 302 by schematic connection 318 through schematic wire 316 and to electrode 302 via schematic connection 320. Connection 320 represent that schematic connection 316 is electrically connected to electrode 302. As with schematic wire 308, schematic wire 316 is only to illustrate that another device (not shown) may be electrically connected to electrode 302.

Conversion of an electrical signal can be achieved by another device (not shown) by creating a potential difference between electrode 302 and electrode 304. Another device (not shown) can be connected by connection 318 and connection 310. For example a voltage of approximately 2.5 to 3 volts generated between electrode 302 and 304 can create plasmons coming from tunneling junction 306. Additionally or alternatively, an approximate voltage of −2.5 to −3 volts can create plasmons that flow in the opposite direction from the example above from tunneling junction 306. The polarity of the potential difference can partially control the direction of the generated plasmons although it is to be appreciated that geometry also affects the direction of the plasmons.

In one exemplary embodiment of device 300, the tunneling-junction 306 can include approximately 5.times.10 2 nanojunctions, which can produce approximately 5.times.10 12 plasmons or more per second with approximately 100 nanoamps of current, with an approximate 2.5 to 3 volt differential across electrode 302 and electrode 306. In this exemplary embodiment, plasmons are created in parallel by the nanojunctions. This embodiment would have a quantum efficiency of the approximate order of 10-1 to 10-3 plasmons per tunneling electron. Thus, approximately 10 10 plasmons or more per second can be generated in a single tunneling junction. If, for example, approximately 50 plasmons were required to represent one bit, this example has the potential for an approximate 100 Gb/sec of digital communications capacity. Additionally or alternatively, a plasmonic waveguide that is coupled to either electrode 102 or electrode 104 may have dimensions, for example, of approximately 60.times.60 nm.sup.2. The plasmonic waveguide may also measure, for example, 20-60 nm thick on the surface, with a lateral dimension as small as 20 nm.

Electrodes 302 or 304 can include gold, silver, other conducting or semi-conducting material. The nanojunctions within tunneling-junction 306 can be formed by rough edges or by the use of nanotechnology. Additionally or alternatively, tunneling-junction 306 may include a material to facilitate the production of plasmons, such as silicon dioxide. The directionally of the plasmonic signal can be determined by the direction of the plasmonic waveguide, the voltage polarity, the geometry of a waveguide, or the geometry of the electrodes. Additionally or alternatively, electrode 302 or electrode 306 may be configured to facilitate coupling to a plasmonic waveguide such as waveguide 200 or 210 in FIGS. 2A and 2B.

Device 300 can achieve high rates of data communication and can be utilized by a semiconductor device. Also, manufacturing of device 300 may be conducted by well known semiconductor fabrication techniques. This enables device 300 to lend itself well to integration with other, more conventional integrated circuit technologies. For example, a central processing unit may be able to communicate utilizing device 300 with other intra-chip devices at a higher data rate than was possible with more traditional wire and/or metallic connections. Additionally or alternatively, connections with other integrated devices can be achieved by utilizing the plasmonic device to transfer data as well either inter-chip or intra-chip. For example, a central processing unit may utilize device 300 to send data to a cache that is located either on the same microchip or that is located on another device, such as one of the embodiments that is depicted by FIG. 1.

Again referring to FIG. 1, continuing in the exemplary embodiment where module 116 includes a cache and microchip module 104 includes memory; microchip module 104 can include plasmonic devices to facilitate receiving data from module 116. If, for example, link 116 was a plasmonic waveguide, microchip module 104 may include a plasmonic device (see FIG. 4) to convert plasmons to an electrical signal.

Referring to FIG. 4 in conjunction with FIG. 1, FIG. 4 is a schematic drawing of a plasmonic device 400 that can convert a plasmon to a photon; and finally convert the photon to an electrical signal.

The plasmonic device 400 has a substrate 402. Plasmon 404 is depicted by an arrow and is guided to optical-conversion assembly 406. Photon 408 is a representation of photon that is created by assembly 406. Additionally, output device 410 is shown and represents a device that can convert a photon to an electrical signal.

When plasmon 404 is guided to optical-conversion assembly 406, a photon 408 is created by converting the plasmon 404 to photon 408. Photon 408 then can cause output device 410 to convert the photon to an electrical signal.

Optical-conversion assembly 406 can include a surface bump, surface hole, a nanoarray or some combination thereof. Additionally or alternatively, optical-conversion assembly 406 can be created by utilizing nanotechnology.

Plasmonic device 400 can be used on a microchip or microchip module (see FIG. 1) and may be made utilizing current semiconductor techniques, e.g. CMOS fabrication techniques. In addition, output device 410 can be a pin diode, a photodiode, an avalanche diode, a p-n junction diode, a phototransistor, a light dependent resistor, a photodetector or other photon detection technology.

Incorporation of device 400 into a microchip can provide an interconnect pathway for high bandwidth communications, while occupying minimal chip area. For example, device 400 can be utilized on a microchip that has an integrated circuit (not shown) coupled to output device 410 to receive data from another device (not shown) that is transmitting data. Additionally or alternatively, the plasmon may enter device either by a plasmonic waveguide (see FIGS. 2A and 2B) that brings plasmons from other places on the same chip and/or plasmonic device 400 may receive plasmons that originate from another microchip, such as depicted in one embodiment of FIG. 1 by links 110, 112, and 114, to communicate data.

Device 400 may be used with accompanying integrated circuitry or may exist on a wholly plasmonic based microchip that doesn't utilize on-board integrated circuitry, e.g. device 400 may interface to a electrical conductor (not shown) that brings the electrical signal from output device 410 to a metal connection on the edge of a microchip so that other devices (not shown in FIG. 4) may connect to the electrical signal via connecting pins (not shown).

Referring back to FIG. 1, as described herein, system 100 is a system utilizing plasmonics for communication. As mentioned supra, a plasmonic device can be employed in module 116, 118, or 110 for intra-chip and/or inter-chip communications; likewise microchip module 104, 106, or 108 can utilize plasmonic devices for intra-chip or inter-chip communications, e.g. communicating between microchip module 102 and 104 via link 110. Links 110, 112, or 114 can be used for communications with microchip module 104, 106, and 108, respectively.

Referring to FIG. 1 in conjunction with the other drawings, consider the following embodiment: an intra-chip communications system where module 116 transfers data to module 104 using plasmons. In this example, microchip module 104 is a separate microchip from microchip module 102. An integrated circuit may be included in module 116 with a plasmonic device 300 as shown in FIG. 3. The integrated circuit may control the generation of plasmons by device 300 in conjunction with an appropriate modulation scheme. The plasmon may then be guided from module 116 to an appropriate on-chip/off-chip connector and finally to microchip 104 via link 110; the plasmonic guiding can be achieved by a plasmonic waveguide such as in FIG. 2A, waveguide 200 or FIG. 2B, waveguide 210. Thus, in this example, link 110 can include a plasmonic waveguide. Finally, plasmons that reach microchip 104 can be converted to an electrical signal by a plasmonic device such as by device 400 which is depicted in FIG. 4. The electronic signal may then be processed by integrated circuitry found on microchip 104, e.g. integrated circuitry that includes memory and associated circuitry.

In an embodiment of system 100 where links 110, 112, and 114 include a plasmonic waveguide to communicate from the microchip modules 104, 106, and 108 to microchip 102, a device such as device 300 (see FIG. 3) can send plasmons from the respective microchip modules to microchip module 102, respectively. For example, plasmons may be generated on microchip 104 by a device such as device 300 as is shown in FIG. 3 to communicate data to module 116, and thus microchip 102, via connection 110.

Links 110, 112, and/or 114 can include one or more plasmonic waveguides using serial and/or parallel data communications. The plasmonic waveguides can be unidirectional or bidirectional; and they may allow duplex, simplex or half-duplex communications. Additionally or alternatively, each plasmonic waveguide may be part of a bus where differing integrated circuitry utilizes a particular waveguide for a particular communication while allowing other integrated circuitry to utilize it as well.

Referring again to FIG. 1, additionally or alternatively, in another embodiment of system 100, links 110, 112, and/or 114 may include a fiber-optic cable. The use of plasmonics may be utilized in conjunction with fiber optics. For an example refer to FIG. 5, which depicts a plasmonic device 500 that can utilize fiber-optics with plasmonics. A schematic of plasmonic device 500 is shown in FIG. 5 and has a substrate 414. Plasmon 404 is depicted by a small arrow and represents a plasmon that is guided to optical-conversion assembly 406 and may be converted to photon 408. Photon 408 is guided by optical waveguide 502 to couple photon 408 to fiber optic cable 504. The guiding of photon 408 is represented by arrows approximately representing the path of travel by path 506.

Device 500 receives plasmon 404 and optical-conversion assembly 408 converts plasmon 404 to photon 408. Photon 408 is guided by optical waveguide 502 approximately down path 506 and is directed into fiber optic cable 504.

Optical waveguide 502 may be a lens, or otherwise may be made of a suitable optical materials with one or more, or varying, refractive indexes as long as the desired optical guiding is achieved. Additionally or alternatively, optical waveguide 502 can be a combination of lenses and may include a biconvex lens, a piano-convex lens, a convex-concave lens, a meniscus lens, a plano-concave lens, a biconcave lense, other lense, or some combination thereof, to achieve the photon guiding.

Additionally or alternatively, fiber optic cable 504 can be multi-mode, single mode or any other fiber-optic cable. Also, fiber optic cable 504 can be part of a wavelength multiplexed system such as a WDM system, a DWDM system, CWDM system, or UDWDM system. The differences in the wavelength of photon 408 can be achieved by either changing plasmon 404 or optical-conversion assembly 406. For example, the frequency associated with plasmon 404 may correspond to an optical channel on a WDM system, or likewise, optical conversion assembly may only convert certain plasmons so that photon 408 has a certain wavelength. In addition or in the alternative, lens 502 may include an optical filter so that only specific and/or desired wavelengths of photon 408 are coupled to fiber optic cable 504.

Referring again to FIG. 1 while referencing the other drawings, in the embodiment aforementioned where links 110, 112, and/or 114 include a fiber optic cable, plasmonic system 500 as depicted in FIG. 5, enables the use of photonics with plasmonics. Consider the embodiment where an integrated circuit located in module 116 communicates data to microchip module 104, e.g. such as in caching. Module 116 can generate plasmons with system 300 as depicted in FIG. 3, with an appropriate modulation technique, for coupling into system 500, as shown in FIG. 5; the coupling can be achieved by waveguide 200 as shown in FIG. 2A, by waveguide 210 as shown in FIG. 2B, or directly. System 300 in FIG. 3, waveguide 200 in FIG. 2A, waveguide 210 in FIG. 2B and/or system 500 in FIG. 5 can be located within or outside of microchip module 102 as shown in FIG. 1.

The photons that may be generated by a system 300 shown in FIG. 3, can travel through link 110 to microchip module 104, where link 110 is coupled to a dielectric/metallic interface to convert the photon to plasmons. Additionally or alternatively, link 110 may be coupled to an optical to electrical converter, e.g. an indium gallium arsenide (InGaAs) detector. The photons could be converted directly to plasmons by directing the fiber optic cable to an appropriate surface nanostructure. Alternatively, the photons are converted to local electrical signals by a photodetector, and these electrical signals modulate a plasmon signal to further transmission of data inter- or intra-chip.

The plasmons can then be coupled to a plasmonic device such as device 400 as shown in FIG. 4 to convert the plasmons to an electrical signal. Additionally or alternatively, a fiber optic cable that may be found in connection 110 can couple to a photodetector (not shown) for conversion to an electrical signal. Although in the above description of an embodiment, a data communication was considered from module 116 to microchip 104, communications can also occur from microchip 104 to module 116 with the same plasmonic devices and/or fiber-optic waveguides.

Again referring to the drawings, FIG. 1 is a system that utilizes plasmons for inter-chip and/or intra-chip communications. There are multiple topologies of inter-chip interconnects that are possible one of which is depicted by FIG. 6.

FIG. 6 is a side view of plasmonic system 600 that has a “flower” type topology for connecting microchip module 602 to microchip module 606 utilizing plasmons. System 600 includes microchip module 602 that connects to microchip module 606 with a plurality of plasmonic waveguides 604. Although, from the side view, flowering is shown as an expansion of distance between each waveguide along the X-axis based upon the plurality of waveguides 604's location as a function of Y-axis position, an expansion can also occur between the plurality of waveguides along the Z-axis as well. Microchip module 606 may include plasmonic devices for converting plasmons to photons and vise-versa. Coupling point 608 is the location where one or more fiber optic cables and/or plasmonic waveguides can interface to plasmonic system 600.

Microchip module 602 and microchip module 606 may be on the same microchip, or may be on different microchips. Microchip module 602 and microchip module 606 may provide an interface to allow high bandwidth connections, using plasmonic waveguides or fiber optics to other chips and/or devices by utilizing coupling point 608. Layer 602 can communicate data through one of the plurality of plasmonic waveguides 604. Also microchip module 606 may further utilizing plasmonic to photonic conversion, such as is possible by plasmonic device 500, shown in FIG. 5. Fiber optic cables are several orders of magnitude larger than plasmonic waveguides, so the flower topology may allow more distance between each of the plasmonic waveguides 604 for converting the plasmons to photons for coupling the photons to a fiber-optic waveguide. Each of the fiber optic cables that can be attached to coupling point 608 can be connected to another device, such as a memory device, a microprocessor, a device that utilizes integrated circuitry, a plasmonic device, or some combination thereof. For example, plasmonic system 600 can provide high bandwidth with low latency between a memory chip (not shown in FIG. 6) and an on-chip memory module (not shown in FIG. 6).

Referring again to FIG. 1, a plasmonic system 100 has communications capability and may utilize multiple topologies. Now refer to FIG. 7, plasmonic system 700 is shown and has a “stack” topology. Microchip modules 702, 204, 706, 708, and 710 are shown; they can be on the same semiconductor device or on differing devices. Microchip modules 702, 704, 706, 708 or 710 can include integrated circuitry and/or plasmonic devices. Plasmonic waveguides 716, 714, and 712 are shown and provide for communicating among the layers. For example microchip module 702 may send plasmons along waveguide 712 to communicate with microchip module 710. In addition, the waveguides can be one or more plasmonic waveguides and can provide either simple, duplex, and/or half-duplex communications and may, additionally or alternatively, function as a bus.

For example, microchip module 706 can be a microprocessor while microchip modules 702, 704, 708, and 710 can include memory; this configuration can be utilized for increased memory performance. In addition, microchip module 702, 704, 706, 709, and 710 may include fiber optic interfaces and/or other plasmonic waveguides. Also, although plasmonic system 700 only shows five microchip modules with three plasmonic waveguides, the embodiment includes two or more layers and one or more plasmonic waveguides.

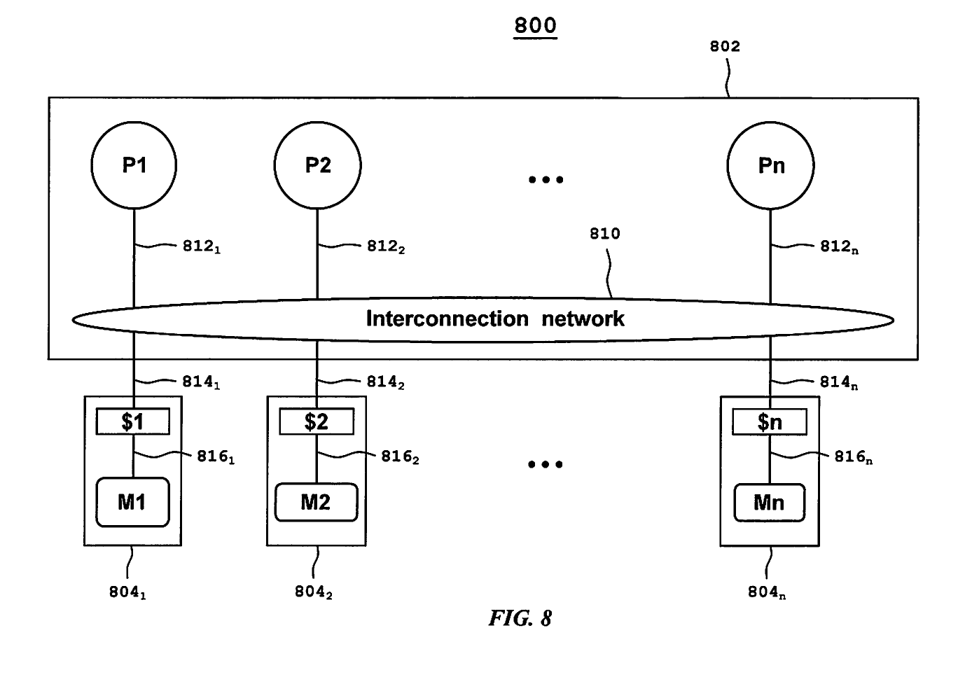

The teachings of the present disclosure can also be applied to computer architectures. That is, the connections of computer architecture can be provided using plasmonics as described herein. FIG. 8 illustrates a computer architecture designated generally by reference numeral 800. Computer architecture 800 is a parallel memory architecture and is partitioned into a plurality of separate computer chips 802, 804.sub.1, 804.sub.2 . . . 804.sub.n Computer chip 802 includes an interconnection network 810 and a plurality of processors P1, P2 . . . Pn. Each processor is connected to the interconnection network 810 via a respective connection 812.sub.1, 812.sub.2 . . . 812.sub.n. Each of the remaining computer chips 804.sub.1, 804.sub.2 . . . 804.sub.n, respectively, includes a cache memory $1, $2 . . . $n, respectively, and a memory M1, M2 . . . Mn, respectively. The n computer chips 804.sub.1, 804.sub.2 . . . 804.sub.n, are connected to the interconnection network 810 of computer chip 802 via a respective connection 814.sub.1, 814.sub.2 . . . 814.sub.n. Additionally, each cache memory and memory of computer chips 804.sub.1, 804.sub.2 . . . 804.sub.n are connected to each other via a respective connection 816.sub.1, 816.sub.2 . . . 816.sub.n. One or more of connections 812.sub.1, 812.sub.2 . . . 812.sub.n, 814.sub.1, 814.sub.2 . . . 814.sub.n, 816.sub.1, 816.sub.2 . . . 816.sub.n are provided by plasmonic devices or waveguides as described herein above by the present disclosure.

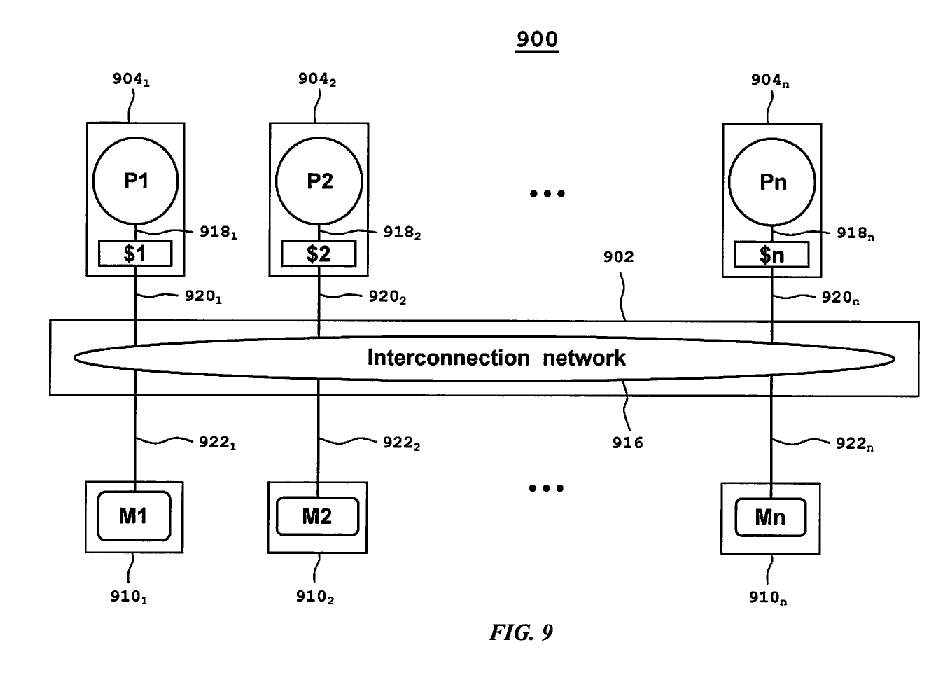

FIG. 9 illustrates another computer architecture designated generally by reference numeral 900. Computer architecture 900 is a parallel memory architecture and is partitioned into a plurality of separate computer chips 902, 904.sub.1, 904.sub.2 . . . 904.sub.n, 910.sub.1, 910.sub.2 . . . 910.sub.n. Computer chip 902 includes an interconnection network 916. Each of computer chips 904.sub.1, 904.sub.2 . . . 904.sub.n include a respective processor P1, P2 . . . Pn and a respective cache memory $1, $2 . . . $n. Each processor is connected to its cache memory via a respective connection 918.sub.1, 918.sub.2 . . . 918.sub.n and each computer chip 904.sub.1, 904.sub.2 . . . 904.sub.n is connected to the interconnection network 916 of computer chip 902 via a respective connection 920.sub.1, 920.sub.2 . . . 920.sub.n. Each of the remaining computer chips 910.sub.1, 910.sub.2 . . . 910.sub.n includes a memory M1, M2 . . . Mn. These computer chips 910.sub.1, 910.sub.2 . . . 910.sub.n are connected to the interconnection network 916 of computer chip 902 via a respective connection 922.sub.1, 922.sub.2 . . . 922.sub.n. One or more of connections 918.sub.1, 918.sub.2 . . . 918.sub.n, 920.sub.1, 920.sub.2 . . . 920.sub.n, 922.sub.1, 922.sub.2 . . . 922.sub.n are provided by plasmonic devices or waveguides as described herein above by the present disclosure.

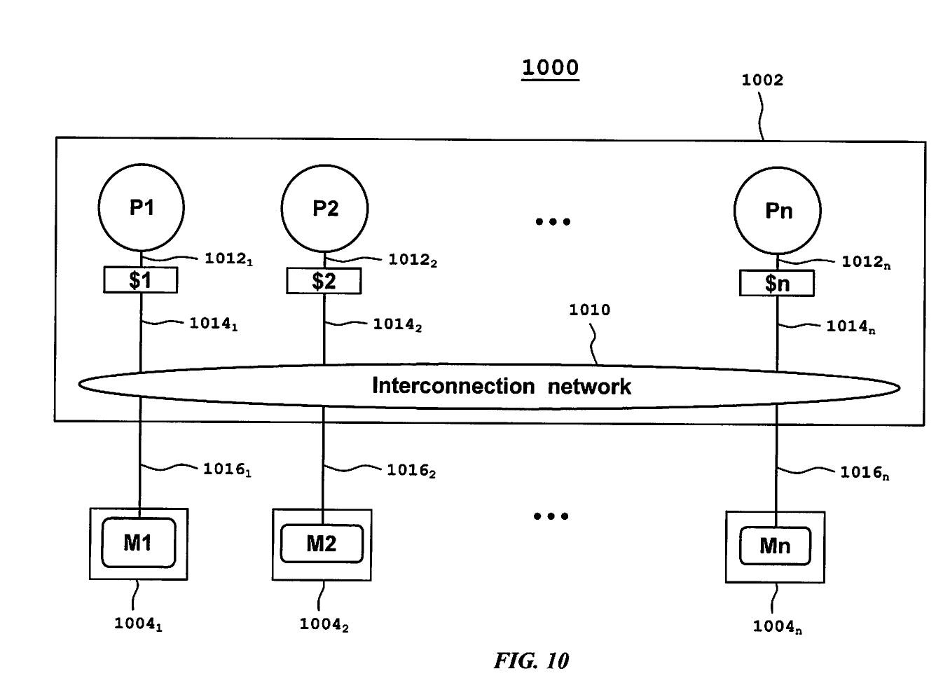

FIG. 10 illustrates another computer architecture designated generally by reference numeral 1000. Computer architecture 1000 is a parallel memory architecture and is partitioned into a plurality of separate computer chips 1002, 1004.sub.1, 1004.sub.2 . . . 1004.sub.n. Computer chip 1002 includes an interconnection network 1010. Computer chip 1002 includes a plurality of processors P1, P2 . . . Pn and, each processor includes a respective cache memory $1, $2 . . . $n. Each processor is connected to its cache memory via a respective connection 1012.sub.1, 1012.sub.2, . . . 1012.sub.n and each cache memory is connected to the interconnection network 1010 via a respective connection 1014.sub.1, 1014.sub.2 . . . 1014.sub.n. Each of the remaining computer chips 1004.sub.1, 1004.sub.2 . . . 1004.sub.n includes a memory M1, M2, Mn. These computer chips 1004.sub.1, 1004.sub.2 . . . 1004.sub.n are connected to the interconnection network 1010 of computer chip 1002 via a respective connection 1016.sub.1, 1016.sub.2 . . . 1016.sub.n. One or more of connections 1012.sub.1, 1012.sub.2 . . . 1012.sub.n, 1014.sub.1, 1014.sub.2 . . . 1014.sub.n, 1016.sub.1, 1016.sub.2 . . . 1016.sub.n are provided by plasmonic devices or waveguides as described herein above by the present disclosure.

A paper of interest is U. Vishkin, I. Smolyaninov and C. Davis, titled “Plasmonics and the Parallel Programming Problem,” to be presented at Silicon Photonics Conference, SPIE Symposium on Integrated Optoelectronic Devices 2007, Jan. 20-25, 2007, San Jose, Calif.; the entire contents of the paper are incorporated herein by reference.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1-11. (canceled)

12. An plasmonic communications system comprising:
a first microchip module; and
a second microchip module in operative communication with the first microchip module via at least one plasmonic waveguide.

13. The system of claim 12, wherein the second microchip module includes an integrated circuit.

14. The system of claim 12, wherein the second microchip module further comprises
a connection point and a plasmonic device, wherein the connection point is configured to interface into at least one fiber optic cable and the plasmonic device, the plasmonic device configured to be in operative communication with the first microchip module utilizing the at least one plasmonic waveguide, the plasmonic device comprising:
a plasmon interface configured to receive a plasmon from the at least one plasmonic waveguide;
an optical-conversion assembly configured to convert plasmons received from the plasmon interface into photons; and
an output device configured to receive a photon from the optical-conversion assembly and guide the photon to the connection point.

15. The system of claim 12, wherein the system includes one of a stack topology and a flower topology.

16. The system of claim 12, wherein the at least one plasmonic waveguide comprises:
an elongated metallic strip defining a length; and
a dielectric material at least partially disposed upon the length of the metallic strip.

17. The system of claim 16, wherein the at least one plasmonic waveguide further comprises another metallic strip at least partially disposed upon the dielectric material opposite to the elongated metallic strip.

18-29. (canceled)

30. A computer architecture comprising:
a plurality of computer chips, at least one of the plurality of computer chips including at least one of an interconnection network, a processor, cache memory, and a memory; and
a plurality of connections connecting the plurality of computer chips, wherein at least one of the plurality of connections includes at least one of a plasmonic device and waveguide.
